(19) United States
(12) Patent Application Publication
(10) Pub. No.: US 2007/0150519 A1
(43) Pub. Date: Jun. 28, 2007

(54) Organiser for complex categorisations

(76) Inventor: Angel Palacios, Madrid (ES)

Correspondence Address: Angel Palacios, Mendez Alvaro 77, Portal 4 Piso 4B, Madrid, 28045, ES

(21) Appl. No.: 10/599,384

(22) PCT Filed: Mar. 29, 2005
(86) PCT No.: PCT/ES05/00165

§ 371 Date: Sep. 27, 2006

(30) Foreign Application Priority Data
Mar. 30, 2004 (ES) P200400776

(51) Int. Cl. G06F 17/30

(52) U.S. Cl. 707/200

(57) ABSTRACT

The invention relates to an organizer for complex categorizations. The development of computer science in general and the Internet in particular has led to an ever-increasing amount of information being made available to a large number of people, many of whom are not computer experts. As a result, new and improved mechanisms are required in order to organize said information and facilitate searches. The invention relates specifically to a type of organization for sets of entities, such as for example, objects, concepts, ideas, terms or other entities, which facilitates the conceptualization of classifications and the implementation of searches. In particular, the invention facilitates the formation of systematic categorizations which contain different criteria for organizing information, as well as facilitating the checking and use thereof by the user.

### TECHNICAL AREA

The present invention falls within the area of computerized tools for facilitating the classification of information.

### PRIOR ART

In the present document the following references are cited:

[1] Amazon. Book browser. www.amazon.com.

[2] Barnes and Noble. Book browser. www.bn.com.

[3] Benson, J. D., Cummings, M., Greaves, W. S. (eds) (1988) “Linguistics in a Systemic Perspective”, Amsterdam: John Benjamins Publishing Company

[4] IBM (2000). U.S. Pat. No. 6,055,515

[5] Microsoft. MSDN Library Visual Studio 6.0

[6] Royal Academy of Spanish Language. Dictionary of Spanish Language. Espasa.

The appearance of informatics in general and of Internet in particular have caused that there nowadays exists a growing amount of information that is available for a great amount of persons, many of whom are not expert user of informatics. For example, there nowadays exists a great variety of databases that are accessible in CD-ROM, DVD or in Internet servers. Some examples of these databases are the following ones:

1. The electronic dictionary of the Royal Academy of Spanish Language.

2. The encyclopedia Microsoft® Encarta®.

3. The help tool in Microsoft® Visual Studio®.

4. The topic hierarchy in Yahoo®.

5. The book catalogs in Amazon®, Barnes and Noble® and other online bookstores.

In general, these databases are organized in such a way that they contain a mixture of many different types of concepts, and searches are difficult to perform. This creates a need for new and better mechanisms for organizing the information and facilitating the execution of searches.

### EXPLANATION OF THE INVENTION

Esence of the Invention

This invention presents an approach for organizing sets of entities, wherein said entities might be for example objects, concepts, ideas, terms or others, which facilitates the conceptualization of classifications and the execution of searches. In particular, the invention facilitates the creation of systematic categorizations in which there exist different criteria for organizing the information, and aids the user in the inspection and utilization of such classifications.

The invention unites in the same tree the categories that are used for classifying the instances that are being classified and the different criteria that define the different hierarchies of categories. That is to say, it creates a multicriteria classification in the same tree, in which coexist different hierarchies that belong to different criteria.

This tree can be graphically shown in an arboreal structure. Exhibit 1 shows a simple example of a possible arboreal structure for a multicriteria classification of words. In order to facilitate the exposition, in this document the term ‘tree’ will be used for the logical organization of entities by means of parent-child relationships, and the term ‘arboreal structure’ will be used for the representation of said tree in a graphical interface.

Also with the purpose of facilitating the exposition, the following guidelines will be followed in the different arboreal structures that will be shown in the document:

the different instances will be written between dots, such as for example “.hammer.”—in the example of Exhibit 1, the instances would be the example words which are shown,

the different categories that will be used will be shown with a normal font characteristics, such as for example “Noun” in the example of Exhibit 1, and

the different criteria that will be used will be shown with underlined font, such as for example “According to nature”, in the example of Exhibit 1.

It must be taken into account that the purpose of the categorization shown in Exhibit 1, and of other categorizations that will be shown below, is only to facilitate the explanation of the invention, and that the particular decisions that will be taken for criteria, categories or instances are only intended as examples, and not to limit in any way the scope of the invention.

Exhibit 1

Words

Noun

According to nature

Entity

.hammer.

.brother.

.writer.

.cherry.

Attribute

.height.

.honesty.

Event

According to duration

Punctual

.arrival.

Durative

.concert.

.storm.

According to action

Action

.concert.

.arrival.

No action

.storm.

Other

.meter.

.field.

According to meaning

Has utilization

.hammer.

Has function

.writer.

Has relationship

.brother.

Other

.height.

Verb

Adjective

Adverb

Closed Class

As can be seen, this approach allows to mix different categories and different criteria in an unlimited way. That is to say, both categories and criteria can be descendent nodes of a criterion. And both categories and criteria can be descendent of a category. In the example shown in Exhibit 1, there is no case in which a criterion is a child of another criterion, but this might happen as well.

As can be seen, the categorization shown in Exhibit 1 can be built in a simple way in a single control of the types used for showing trees; it could be shown, for example, in a tree control of those which are customarily used, such as the Microsoft Treeview® control, which is used in the directory structure of the operating system Microsoft Windows®. In this case, both criteria and categories could be implemented as nodes of the arboreal structure that the control represents.

As can also be seen, in order to facilitate the utilization of the invention, in general, there might optionally exist graphical means that would allow to distinguish criterion-nodes from category-nodes, such as has been done in Exhibit 1, for example, using underlined font for criterion-nodes, even though it would be possible to use other type of means.

As can also be seen, instances can belong to different categories; in particular, they will normally belong to different categories that are descendents of sister criterion-nodes. For example, in Exhibit 1, “.arrival.” belongs to “According to duration>Punctual” and it also belongs to “According to Action>Action”. Depending on the criterion that is taken into account, the word will belong to different categories. As is customarily done in the prior art, the arboreal structure can show the different instances in a duplicated or repeated fashion in different positions that correspond to different categories. That is to say, “.arrival.” is located both in “According to duration>Punctual” as in “According to Action>Action”.

Finally, the invention applies both to a case in which no instances exist yet, and therefore only criteria and categories appear, and to the case in which there exist instances that are shown.

Moreover, the invention can be used in a case in which only criteria and categories are shown and instances are not shown. In this case, categories and criteria could be used to execute searches against a database in which the instances are stored.

Optional Features

The invention allows to implement different embodiments that have different optional features. In order to facilitate the explanation of the advantages of the invention, and without any limiting intention, some of these optional features are explained below:

1. A relational database is used which contains two tables. One table is used for storing the instances and the other table is used for storing categories and criteria.

2. A different code is assigned to each record of the category-criterion table (i.e., each category and each criterion have a different code). For example, a numeric code is assigned where each code is an integer number.

3. A special field is created in the instance table, called for example “Classification”,

4. For each instance, the categories to which the instance belongs are identified and the codes of those categories are concatenated, creating a string, and some delimiting character is used in both sides each of the codes. In a hypothetical case, the linked string could be a string such as

this one “-1-23-42-100-230-”.

5. The linked string for the codes of each instance is stored in the field “Classification” of each instance.

With the previous method, it would be possible to undertake very powerful searches on the instances. It could be possible for example to execute queries on the instances that have certain categories by using the SQL command “Like” or another similar command in other database language. For example, if the user wants to find instances that are assigned to the category whose code is “1”, the query condition could be “Classification LIKE ‘-1-’”. This condition would retrieve all the instances that would have the term “1” in its classification. As can be seen, the utilization of delimiting characters prevents wrong results from being retrieved, such as for example would happen with the code “100”; without the delimiting characters, it might happen that this wrong code would be retrieved, because the command “LIKE” would consider that “100” contains a character “1”.

There is another optional feature that is helpful for executing queries, and which is characterized by the fact that the user can select a set of categories, which can belong or not to different classification criteria, and the system would search for those instances that have certain relationship with those categories. For example, for the data in Exhibit 1, the user could select only the category “Entity” (which is hanging from Noun>According to Nature) and the system would return the instances: “.hammer.”, “.brother.”, “.writer.”, and “.cherry.”, i.e. all the instances that belong to the category “Entity”. Alternatively, if the user selects simultaneously “Entity” and “Has utilization” (where “Has utilization” is hanging from Noun>According to meaninng), the system would only return “.hammer.”, because it is the only instance that belongs to both categories. The user can perform queries as complex as he/she wishes by using boolean expressions in order to refine the conditions that must be imposed over the categories that are selected. For example, if the user selects “Entity” and NO “Has utilization” (where “NO” is the boolean function ‘negation)’ the system would return only “.brother.”, “.writer.” and “.cherry.”.

In order to even more ease query formulation, a useful optional feature is the SUMMARY ARBOREAL STRUCTURE. A summary arboreal structure is an arboreal structure that only contains the nodes that are selected in the main arboreal structure at a given moment. For example, in Exhibit 1 it is possible to select certain nodes, such as for example the ones that are shown in bold font in Exhibit 2. A possible summary arboreal structure for this structure would be the structure shown in Exhibit 3.

Exhibit 2

```
Words
  Noun
    According to nature
      Entity
        .hammer.
        .brother.
        .writer.
        .cherry.
      Attribute
        .height.
        .honesty.
      Event
        According to duration
          Punctual
            .arrival.
          Durative
            .concert.
            .storm.
        According to action
          Action
            .concert.
            .storm.
          No action
            .storm.
      Other
        .meter.
        .field.
    According to meaning
      Has utilization
        .hammer.
      Has function
        .writer.
      Has relationship
        .brother.
      Other
        .height.
  Verb
  Adjective
  Adverb
  Closed Class
```

Exhibit 3

```
Words
  Noun
    According to nature
      Entity
      Event
        According to action
          Action
    According to meaning
      Has relationship
```

In order to further ease the management of the selected nodes, the information of the summary arboreal structure could also be shown as appears in Exhibit 4.

Exhibit 4

Words > Noun > According to nature > Entity
Words > Noun > According to nature > Event >
According to action > Action
Words > Noun > According to meaning > Has relationship

It is also possible to add a nickname to the selected nodes, in order to more easily use them in queries, as shown in Exhibit 5.

Exhibit 5

| Node | NICK |
|---|---|
| Words > Noun > According to nature > Entity | Entity1 |
| Words > Noun > According to nature > Event > | Action1 |
| According to action > Action | |
| Words > Noun > According to meaning > Has relationship | Relation1 |

One more optional feature that can be implemented is related with query generation after a selection of instances. When selecting an instance, it is possible to automatically select the categories to which that instance belongs, and the user then can take those categories as the starting point to generate queries.

### ADVANTAGES OF THE INVENTION

1. It allows to easily merge categorizations that are based on different criteria, so that the user can easily comprehend the effects of the multi-categorization.

2. It allows to easily perform sophisticated queries, because the user only has to select in the same control all the categories that he/she wishes, and then only has to combine them in order to create the query.

3. It allows to create simple user interfaces, because it allows to create multicriteria classifications with a single tree control.

4. It allows to flexibly create databases. It the user wants to change anything in the nodes of the tree, he/she only needs to add more records to the data base (in order to create additional nodes) and modify the field “Classification” for the instances, so it is not necessary to modify the structure of the database.

5. It allows to flexibly create user interfaces. If the user wants to change anything, such as for example adding or removing any criterion, it is not necessary to modify the programs that manage the arboreal structure nor modify the ones that manage the user interface, because the only thing that must be done is adding more nodes to the tree.

6. If facilitates the application of data mining systems, because different categories can be evaluated in an independent fashion. For the example of Exhibit 1, it is possible to analyze the word “.writer.” from the point of view of “Has Function” and from the point of view “Entity”.

The queries that are based on commands such as “LIKE” are relatively slow, which is a disadvantage. However, when the database is being created, which is when flexibility is more needed, there are normally few records, and therefore the effects of this disadvantage are smaller.

If the user wants to increase the speed of the queries, he/she can modify the structure of the database, adding new fields for “Classification”, so that the different categories can be spread over different fields, which would speed up the execution of searches. In these circumstances, it is possible to decide that certain fields will host the categories that might experience the least variation, and create one or more fields to host those linked codes that belong to the categories that can vary the most.

Comparison with Other Proposals that Exist in the Prior Art.

As far as has been known, there do not exist proposals like this invention, even though some proposals share some features. The most similar proposals are the following ones:

Proposals in systemic linguistics. In this school of linguistic research many linguistic taxonomies are normally performed. A sample of papers on this area can be found in [Benson et al 1988]. In the tradition of systemic linguistics, linguistic entities are categorized by using diagrams that have some characteristics similar to those of the diagram shown in FIG. 1, which has been taken from [Benson et al 1988, p.326]. In these diagrams it is possible to see that some parts correspond to categories, and some other parts are similar to what in this invention is called criteria.

However, despite the fact that this type of diagrams have been used since a long time ago (at least since 1988, which is the date of the reference), and despite the fact that there exist several computer tools to manage this type of diagrams, as far as has been known there are no proposals that are similar to the one in this invention. The diagrams that are used in this tradition have the same format as a two dimensional picture, as shown in FIG. 1, which is much more difficult to use than a tree control as the Microsoft TreeView control. For example, these diagrams do not have the selection possibilities that tree controls have, such as expanding and collapsing nodes. Furthermore, the diagrams expand from left to right and top down, which make it difficult to manage the user interface. Moreover, it is necessary to create special purpose computer programs in order to manage these diagrams. Additionally, there dos not exist a clear distinction between criteria and categories. It has not been possible to find any proposal where all the diagram is integrated into a control in such a way that can be easily used.

In contrast, the invention described in this document can be easily implemented in a standard tree control, such as the Microsoft Treeview® control, or linking text strings in HTML language.

Classifications where diverse aspects appear in a mixed fashion. In this proposals, the classifications have some nodes that represent categories, other ones that might resemble criteria but which actually are not criteria, and other ones that represent additional aspects. Most of the proposals that have been found correspond to classifications where different aspects are mixed. In these proposals there is no method for classification and search that facilitates the user the utilization of the categorization. Nodes of different types appear in a mixed fashion, which creates confusion to the user. A selection of some proposals of this type is the following one: [Royal Academy of Spanish Language], [IBM 2000], [Microsoft]. [Amazon], [Barnes and Noble].

For example, in [Royal Academy of Spanish Language], it is possible to see a classification such as the one shown in Exhibit 6 (In the Exhibit, criteria and categories have been translated into English, but instances remain in Spanish). In this proposal, it is possible to select any of the existing categories in order to explore the instances that depend on that category. In the proposal, there do not really exist nodes that correspond to what in the present invention is called “criteria”. Even though some nodes might look like classification criteria, actually they are categories. For example, the adjective “.alto.” (“tall” in English) does not appear under the category-node “gender−>masculine”, but it is reserved for those adjectives that are only masculine, and they do not appear in the category “adjective”. The adjective “.altisimo.” (“very tall” in English) only appears in “levels−>superlative”, and the adjective “.encinta.” (“pregnant”) only appears in “gender−>feminine”. However, the word “.tanto.” (similar to “both”) appears both in “adjective” and in “uses as adjective”.

Exhibit 6

```
adjectives
  adjective
    .alto.
    .tanto.
  uses as adjective
    .tanto.
gender
  masculine
    .alto.
  feminine
    .encinta.
  invariable
levels
  comparative
  superlative
    .altisimo.
types
  anaphoric
  descriptive
  demonstrative
  epithet
  gentilic
  indefinite
  possessive
Latin adjectives
adjective locutions
```

In [Microsoft] it is possible to see a classification as the one shown in Exhibit 7 (many nodes have been omitted in order to facilitate the exposition). In this case the tree contains a great variety of topics, which are organized in the same way as the manner in which they could have appeared in a book that was structured in chapters and epigraphs, and it happens that some instances appear in several nodes, such as for example the control “CheckBox Control”. However, this is not a classification like the one proposed in this invention because, among other things, it does not have the criterion-node concept.

Exhibit 7

```
MSDN Library Visual Studio 6.0
  Welcome to the MSDN Library
  Visual Studio Documentation
  Visual Basic Documentation
    Using Visual Basic
Reference
  Language Reference
    Objects
      .CheckBox Control.
    Properties
  Controls Reference
    Intrinsic Controls
      .CheckBox Control.
```

In [IBM 2000] it is possible to see a classification like the one shown in Exhibit 8, which in [IBM 2000] is used as an example to propose an invention related to browsers for classifications.

Exhibit 8

```
Application
  Accountancy
    .ABC-123.
    .XYZ-890.
  .Programming.
  .Typing.
Catalog
  .Desktop Publishing.
  Spreadsheet
    .ABC-123.
    .XYZ-890.
  .Word processing.
Manufacturer
  Company A
    .ABC-123.
  Company B
    .XYZ-890.
```

Given that this classification is only a limited example, it is difficult to know exactly the intention of the authors of this patent. However, the most appropriate interpretation is that this proposal is again a classification that mixes heterogeneous entities, such as in [Microsoft]. The reasons that explain this are the following ones:

1. The intention of the author is only to show a classification that contains multiple paths to an instance, independently of whether those multiple paths exist because there exist several criteria. An alternative classification in this respect might be the one shown in Exhibit 9, in which the product .XXX. might appear in two different nodes, and which however has no relationship with the current invention. The following sentences extracted from the patent show that that was the intention of the authors: “enter items that can be subcategories or products of several different categories”, and “a user should be able to navigate to a pair of sunglasses by following a path through many categories, such as beach wear, or sportswear of eye care”, wherein the situation that is described by this last sentence is represented in Exhibit 10.

2. In [IBM 2000] the discussion always mentions categories and products, and no distinction is made between category types, which shows clearly that the criterion concept does not appear in the text.

3. The classification that is shown only mixes different concepts, as is proven by the fact that there exist three root nodes, which do not depend on a single category node, in a similar way as how [Microsoft] links different concepts. If this classification had been taken from a real situation, there would probably exist other concepts, which is what happens in [Microsoft]. For example, as shown in Exhibit 11, the classification might include products such as printers, which depend on the node “Manufacturer”, which however do not fit in the category “Application”.

4. The classification implements multiple inheritance, as the authors mention “subcategories or product inherit both the definition and any assigned values from their categories”. In these circumstances, it is not possible to interpret that the nodes “Application”, “Catalog”, and “Manufacturer” are criteria, being on the other hand category-nodes.

5. Two nodes that might be criteria, “Application” and “Catalog” are parents of nodes that are not categories, these nodes apparently being products (“Programming”, “Typing”, “Desktop Publishing”, “Word processing”)

6. Given the fact that the authors are patenting an enhanced browser to be used with classifications, if they had had the intention of showing the innovative aspects that are presented in the invention of this patent application, they would have mentioned them, but the do not do it.

Exhibit 9

```
Application
  Data management
    .XXX.
  Simulation
    .XXX.
  Accountancy
    .XXX.
```

Exhibit 10

```
Products
  For the beach
    .sunglasses.
  For practicing sports
    .sunglasses.
  For eye care
    .sunglasses.
```

Exhibit 11

```
Application
  Accountancy
    .ABC-123.
    .XYZ-890.
  .Programming.
  .Typing.
Catalog
  .Desktop Publishing.
  Spreadsheet
    .ABC-123.
    .XYZ-890.
  .Word Processing.
Manufacturer
  Company A
    .ABC-123.
    .Printer UVW.
  Company B
    .XYZ-890.
```

The last example of a classification that contains different types of mixed categories is [Barnes and Noble]. In some points in the browsing process, the system shows tree fragments that contain some similarities with the present invention, such as in Exhibit 12. However, this proposal is far from the present invention, because as is the case with other proposals, it contains criteria and categories which are mixed, and the categories vary as the search progresses. For example, at startup there are two different categories “Business” and “History”, and later in the process there exists a different category called “Business History”.

In order to better comprehend the difference between this system and the approach proposed by the current patent application, Exhibit 14 shows how this search classification would be structured if it had been created along the lines of the current invention.

Exhibit 12

```
Fiction
  Fiction and literature
  Graphic novels
  Horror
  Mystery and crime
Other ways to search
  Audiobooks
  Spanish
  Sale
  Recommended
  Large Print
```

Exhibit 13

```
Formats
  Hard cover
  Soft cover
  Soft cover special
  Audio
  Large Print
```

Exhibit 14

```
According to origin
    Fiction
    Non Fiction
According to content
  Usually fiction
      Horror
      Mystery and crime
      Romance
      Thriller
  Usually non fiction
      Business
        Accounting
        Business and commercial legislation
        Business history
        Africa
      Gastronomy, cuisine and wine.
      History
According to format
    Paper
    Audio
    e-Book
```

Assessment of the Novelty and Inventive Step of the Invention

The explanation given in the previous section shows the advantages of the invention. It has also shown several proposals that exist in the prior art that share some characteristics with the present invention, but which are nonetheless different.

Despite the fact that many of the features of the present invention are included in other proposals, no proposal contains all the features simultaneously. Each one of the classification systems that have been shown presents certain problems that the present invention solves by the grouping all those features and by adding some more.

The proposals that were presented have existed for some time already. [Benson et al 1988] is from 1988. [Microsoft] existed before 2000. [Royal Academy of Spanish Language] existed before 2002. The patent [IBM 2000] was filed in 1996.

The fact that so long time has passed without the appearance of a proposal like the present invention proves the inventive nature of it.

### DESCRIPTION OF THE FIGURES

FIG. 1 shows a diagram like the ones used in systemic linguistics.

FIG. 2 shows a block diagram of the preferred embodiment.

FIG. 3 shows a schematic example of the look of the preferred embodiment for a classification fragment.

FIG. 4 shows a block scheme of an alternative embodiment.

### EXPOSITION OF AN EMBODIMENT OF THE INVENTION

### Description of the Preferred Embodiment

In the preferred embodiment, the invention is built on a computerized system, which can be based, for example, on the personal computer Dell® Dimension XPS®, to which a mouse and a keyboard have been added for the user to interact with the system. In the computerized system there exists an operating system that might be, for example, Microsoft® Windows 2000®.

FIG. 2 shows a block diagram of the preferred embodiment, in which the following components can be seen: a screen 2001 to observe the performance of the invention; a processing unit 2002 that produces the functionality of the invention; some interaction means 2003, which would be for example a mouse, a keyboard, an optical pen or other means; and some data 2004 that contain the categories, criteria and instances that are being classified by the invention.

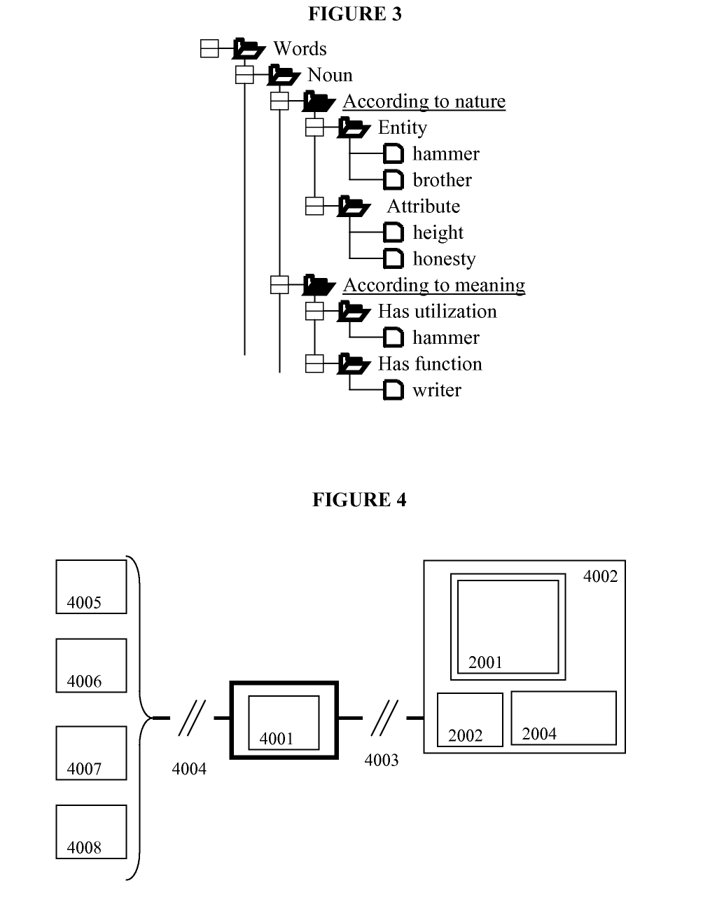

Additionally, the invention uses a computer tree control, such as for example the Microsoft TreeView® control. FIG. 3 schematically shows how an arboreal structure could be created according to the current invention for a fragment of the classification of Exhibit 1.

In the preferred embodiment, the following means are used to distinguish the criterion-nodes from the other nodes.

1. A folder icon, with a mark in the center

2. The node text starts with “According to . . . ”

3. Red font text (which in this document is replaced by underlined font in FIG. 2)

The invention is used to perform queries upon a set of instances which are categorized. In order to do that, it is first necessary to have categorized those instances, i.e. to have assigned the categories to which the instances belong within the different criteria. In the preferred embodiment, two special methods are used in order to facilitate the categorization of instances.

The concept of DOMAIN will be presented here. A domain is a set of sister criteria that includes all the sisters of said criteria. In these circumstances, if a given instance belongs to a category that belongs to one of the criteria, it must also belong to some category of each one of the other criteria that belong to the do main. For example, in Exhibit 1, the nodes that are children of “Noun>According to nature>Event” make up a domain (the domain is composed by the nodes “According to duration” and “According to action”). If an instance has the category “Event”, it means that it must also have one or more of the categories that depend on it, which means that it must also have at least a category of each one of the criteria that belong to this domain (“According to Duration” and “According to Action”)

In these circumstances, an incomplete criterion is a criteria for which no category has been selected, even though at least one should have been selected. A complete criterion is a criterion for which the minimum number of categories have been selected. A neutral criterion is a criterion for which it is not necessary to select any category, and for which in fact there exists no selected category.

For example, in Exhibit 1, if the word “hammer” is being categorized and the category “According to nature>Entity” has been selected, the user must also select a category that belongs to the criterion “According to meaninng”, because those criteria belong to the same domain. However, it is not necessary to select any category belonging to the criteria “According to duration” or “According to action”. On the other hand, if the selected category was “According to nature>Event>According to duration>Punctual”, it would be necessary to select at least a category that belongs to the criterion “According to action”, because they would belong to the same domain.

The method for categorizing instances comprises the following steps:

1. Selecting the instance that is to be categorized

2. Selecting a set of category nodes in the tree, with the purpose of indicating the categories to which the instance will belong

3. Identifying the complete, incomplete and neutral criteria (this step would be carried out by the invention).

4. Marking with graphical means the complete, incomplete and neutral criteria (this step is also carried out by the invention) with the purpose of facilitating the user to evaluate the current selection. In the preferred embodiment, complete criteria are marked with green background color, incomplete criteria with red background color (and white foreground color) and neutral criteria are not marked.

The method for performing searches is carried out as explained below. The user must select a set of categories, and the invention will search the instances that correspond to those categories. In this case, it is possible to leave some criteria as incomplete. If a criterion is left incomplete, such as for example “According to nature”, the system will not use the categories belonging to said criterion for performing the search.

Usually, more than one category will be selected. In these circumstances, it will be necessary to specify the boolean relations that must be applied, unless they are implicitly defined. For example, in Exhibit 14, if the user selects “Horror” and “Thriller”, it will be necessary to specify whether he/she means “Horror AND Thriller”, “Horror OR Thriller” or other boolean combination.

In the preferred embodiment, there exists a single database for each object type (for example a database for words, a database for books, etc) and in each database there exist two tables. One of the tables is used to store instances, and the other one is used to store categories and criteria. In both tables, the database system assigns correlative numeric codes to the entities that are created, (instances, categories or criteria). In order to create the classifications of the instances, hyphens are used around the codes of the categories to which the instance belongs, such as for example in “-1-23-22-”.

### Description of other Embodiments

It is possible to create other embodiments with a different choice of components for the computerized system, such as for example a different computer, a different tree control, a different operating system, or a different element in general.

So far, it has been assumed there were three types of nodes (criterion-nodes, category-nodes and instance-nodes). In other embodiments there might be more types of nodes. For example, it is possible to also use a superhierarchy-node that might add specific properties for the characteristics that depend on it.

FIG. 4 shows another possible embodiment of the invention, which comprises a processing unit 4001 that executes a program with the capacity to organize entities in the manner explained in this invention. This would be the case, for example for a company that is providing a data access service through Internet, to which the user would remotely access by personal computers.

In this embodiment, the invention can be used via an independent computerized system 4002, to which the invention is linked by a telecommunication system 4003. The data that are managed by the unit 4001 are integrated with the unit 4001, or they might be distributed, such as for example are the data 4005, 4006, 4007, 4008, to which the unit 4001 would link by a telecommunications system 4004.

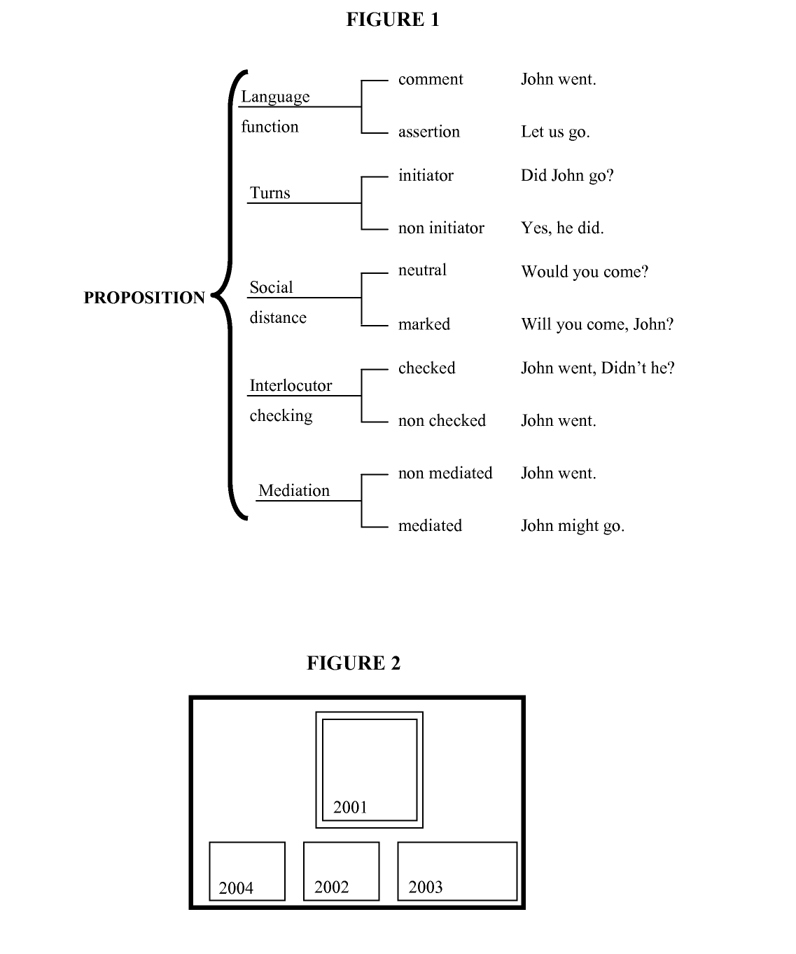

In general, the most useful arboreal structures are of the tower type, which are characterized by the fact that the different nodes are located ones on top of the others, and the nodes are differentiated, mainly, by the indentation level. The Exhibits that are shown in this document and the Microsoft Treeview® control are examples of structures of the tower type. These structures are much easier to use than the ones that are used, for example, in systemic linguistics, such as the one that is shown in FIG. 1.

In addition to the embodiments that are based on controls such as the Microsoft Treeview® control, it is possible to create arboreal structures by using text controls and placing them in a vertical fashion, and applying different indentation levels to the different text controls. An example of these structures are the ones that are created in Internet pages by using HTML language, and it would be very similar to the structures that are shown in the Exhibits of this document.

In other embodiments it is possible to create arboreal structures that do not comprise the functionality for expanding and collapsing nodes, but they are permanently expanded. In this case, the main advantage of the invention is the separation of criteria and category and the methods to manage searches and categorization.

It is possible also to implement the invention with different designs of arboreal structures. One of these designs is shown in Exhibit 15. In this arboreal structure, the level of the criterion nodes is not higher than the level of the categories that they directly dominate, but they are simple differentiated by the text and format, but they have the same level of indentation. This design of arboreal structure facilitates to see the relation between categories with their parent categories, such as can be seen for example when inspecting “Noun” and “Entity”, where it is clear that “Entity” is a category that depends directly on “Noun”. In this arboreal structure, a criterion can be expanded or collapsed, and the result would be that the categories that depend on it would appear or disappear without making the criterion-node itself disappear. For example, if the criterion “According to nature” is collapsed, the result would be as shown in Exhibit 16.

Exhibit 15

```
Words
  Noun
  According to nature
  Entity
    .hammer.
    .brother.
    .writer.
    .cherry.
  Attribute
    .height.
    .honesty.
  Event
    According to duration
    Punctual
      .arrival.
    Durative
      .concert.
      .storm.
    According to action
    Action
      .concert.
      .arrival.
    Non action
    .storm.
  Other
    .meter.
    .field.
  According to meaning
  Has utilization
    .hammer.
  Has function
    .writer.
  Has relationship
    .brother.
  Other
    .height.
Verb
  Adjective
  Adverb
  Closed Class
```

Exhibit 16

```
Words
  Noun
    According to nature
    According to meaning
    Has utilization
      .hammer.
    Has function
      .writer.
    Has relationship
      .brother.
    Other
      .height.
  Verb
  Adjective
  Adverb
  Closed Class
```

1. A computerized classification system, comprising the following means:
means for organizing entities that have different types,
means for organizing some or all of said entities in a tree, with parent-child relationships, so that said entities correspond to the nodes of said tree, where it is not necessary that a graphical representation of said tree exists,
means for managing, at least, category-entities and criterion-entities, and optionally also instance-entities,
wherein:
said instance-entities might correspond to objects, concepts, events, characteristics, ideas or other entity type belonging to any realm of reality,
the purpose of said category-entities is to create different classes to which said instance-entities can be assigned,
the purpose of said criterion-entities is to create different classification criteria, after which different category-entities can be created,
wherein said system can be of different types, such as for example one of the following ones:
an independent computerized system that comprises a screen and other means,
a computerized system that might not have a screen but which comprises telecommunication means for the user of the invention to connect with said system, in a way that in order for said user to establish said connection, said user might use a second computerized system that might have a screen,
a different type of system with different characteristics.

2. A system as claimed in claim 1, further comprising means for showing an arboreal structure that represents said tree, wherein there might exist different ways to implement said arboreal structure, wherein it is possible that all of the instance-entities, or only part of them, or none of them, appear in said arboreal structure, and where it happens that:
the instance-entities that appear in said arboreal structure could be represented as belonging to all the category-entities to which they belong or only to some of them,
in said arboreal structure, the criterion-entities and the category-entities could alternate, so that a criterion-entity could be the parent of a category-entity and vice versa, and a criterion-entity can be parent of other criterion-entities,
wherein in such arboreal structure the category-instances that are child of criterion-instances can have the same level of indentation or a different level of indentation as said parent criterion-instances.

3. (canceled)

4. A system as claimed in claim 2, further comprising means for emphasizing the criterion-entities with respect to the rest of entities in said structure, wherein said means could be for example a special text, a special font type, a special font format, or other means.

5. A system as claimed in claim 2, further comprising means for showing a summary arboreal structure for the selections that are performed in the main arboreal structure.

6. (canceled)

7. (canceled)

8. A system as claimed in claim 2, further comprising means for modifying said tree—such as for example for adding or removing entities—without requiring to modify the number of controls that exist in the graphical interface in which said arboreal structure is shown, so that the only modification that is necessary to make is to modify the set of nodes that exist in said arboreal structure.

9. A system as claimed in claim 2, further comprising means for categorizing instance-entities in such as way that the user adds an instance-entity in different positions of said arboreal structure and said system creates a classification for said instance-entity that reflects the category-entities that appear as parent node of said instance-entity.

10. A system as claimed in claim 1, further comprising means for modifying said tree—such as for example for adding or removing entities—without requiring to modify the computer system that manages said tree, so that the only modification that must be made is modifying the number of records that exist in the databases where the entities are stored.

11. A system as claimed in claim 1, further comprising means for identifying the criterion-entities that are complete, incomplete and neutral, so that the user can assess whether there exist too many selected category-entities or too few, in order to make a correct categorization of one or more instance-entities.

12. A system as claimed in claim 1, further comprising means for performing searches on instance-entities, so that the search strings are built after one or more category-entities or instance-entities that might have been selected.

13. A system as claimed in claim 1, further comprising means for classifying instance-entities by using certain classification strings, wherein:
said classification strings are character strings,
said classification strings are characterized by being a concatenation of the codes assigned to said instance-entities, wherein said codes can be of several types, such as for example,
codes of the category-entities to which each instance-entity is assigned,
codes of the criterion-entities to which said category-entities belong,
other types of codes,
said classification strings comprise certain separating characters that allow to distinguish where each of the codes starts and ends, with the purpose of eliminating the ambiguity created by the same characters existing in different codes,
and wherein there exist means for storing said classification strings in a database, so that they can be stored in a single field or in several fields in a disaggregated fashion, and wherein said database can be a relational database or other type of database.

14. A system as claimed in claim 11, further comprising means for searching instance-entities by using said classification strings, wherein said search is based on finding the instances in whose classification strings there exist certain sets of characters, for which said means can use mechanisms such as the expression “LIKE” of SQL (Structured Query Language) or other similar mechanisms.

15. A computerized method for classifying entities of different types, comprising the following steps:
adding category-entities and criterion-entities to the classification and, optionally, also adding instance-entities, wherein
said instance-entities might correspond to objects, concepts, events, characteristics, ideas or other entity type belonging to any realm of reality,
the purpose of said category-entities is to create different classes to which said instance-entities can be assigned,
the purpose of said criterion-entities is to create different classification criteria, after which different category-entities can be created,
organizing some or all of said entities in a tree, with parent-child relationships, so that said entities correspond to the nodes of said tree, where it is not necessary that a graphical representation of said tree exists,
wherein said method is based on a computerized system that can be of different types, such as for example one of the following ones:
an independent computerized method that comprises a screen and other means,
a computerized method that might not have a screen but which comprises telecommunication means for the user of the invention to connect with said method, in a way that in order for said user to establish said connection, said user might use a second computerized method that might have a screen,
a different type of method with different characteristics.

16. A method as claimed in claim 15, further comprising the step of showing an arboreal structure that represents said tree, wherein there might exist different ways to implement said arboreal structure, wherein it is possible that all of the instance-entities, or only part of them, or none of them, appear in said arboreal structure, and where it happens that:
the instance-entities that appear in said arboreal structure could be represented as belonging to all the category-entities to which they belong or only to some of them,
in said arboreal structure, the criterion-entities and the category-entities could alternate, so that a criterion-entity could be the parent of a category-entity and vice versa, and a criterion-entity can be parent of other criterion-entities,
wherein in such arboreal structure the category-instances that are child of criterion-instances can have the same level of indentation or a different level of indentation as said parent criterion-instances.

17. (canceled)

18. (canceled)

19. (canceled)

20. (canceled)

21. (canceled)

22. A method as claimed in claim 16, further comprising the step of modifying said tree—such as for example for adding or removing entities—without requiring to modify the number of controls that exist in the graphical interface in which said arboreal structure is shown, so that the only modification that is necessary to make is to modify the set of nodes that exist in said arboreal structure.

23. A method as claimed in claim 16, further comprising the step of categorizing instance-entities in such as way that the user adds an instance-entity in different positions of said arboreal structure and said system creates a classification for said instance-entity that reflects the category-entities that appear as parent node of said instance-entity.

24. A method as claimed in claim 15, further comprising the step of modifying said tree—such as for example for adding or removing entities—without requiring to modify the computer method that manages said tree, so that the only modification that must be made is modifying the number of records that exist in the databases where the entities are stored.

25. A method as claimed in claim 15, further comprising the step of categorizing instance-entities, where said step comprises the following substeps:
said classification strings are character strings,
automatically identifying the criterion-entities that are complete, incomplete and neutral, so that the user can assess whether there exist too many selected category-entities or too few.

26. A method as claimed in claim 15, further comprising the step of performing searches on instance-entities, so that the search strings are built after one or more category-entities or instance-entities that might have been selected.

27. A method as claimed in claim 15, further comprising the step of classifying instance-entities by using certain classification strings, wherein:
said classification strings are character strings,
said classification strings are characterized by being a concatenation of the codes assigned to said instance-entities, wherein said codes can be of several types, such as for example,
codes of the category-entities to which each instance-entity is assigned,
codes of the criterion-entities to which said category-entities belong,
other types of codes,
said classification strings comprise certain separating characters that allow to distinguish where each of the codes starts and ends, with the purpose of eliminating the ambiguity created by the same characters existing in different codes,
and wherein said classification strings might be stored in a database, so that they can be stored in a single field or in several fields in a disaggregated fashion, and wherein said database can be a relational database or other type of database.

28. A method as claimed in claim 27, further comprising the step of searching instance-entities by using said classification strings, wherein said search is based on finding the instances in whose classification strings there exist certain sets of characters, for which said means can use mechanisms such as the expression “LIKE” of SQL (Structured Query Language) or other similar mechanisms.

29. (canceled)

30. (canceled)

31. (canceled)

32. A computer program that, when executed by one or more processors of a computer, allows said one of more processors to perform the following steps:
creating a classification of entities,
adding category-entities and criterion-entities to the classification and, optionally, also adding instance-entities, wherein
said instance-entities might correspond to objects, concepts, events, characteristics, ideas or other entity type belonging to any realm of reality,
the purpose of said category-entities is to create different classes to which said instance-entities can be assigned,
the purpose of said criterion-entities is to create different classification criteria, after which different category-entities can be created,
organizing some or all of said entities in a tree, with parent-child relationships, so that said entities correspond to the nodes of said tree, where it is not necessary that a graphical representation of said tree exists.

33. A computer readable medium containing computer executable instructions that, when interpreted by one or more processors of a computer, allows said one of more processors to perform the following steps:
creating a classification of entities,
adding category-entities and criterion-entities to the classification and, optionally, also adding instance-entities, wherein
said instance-entities might correspond to objects, concepts, events, characteristics, ideas or other entity type belonging to any realm of reality,
the purpose of said category-entities is to create different classes to which said instance-entities can be assigned,
the purpose of said criterion-entities is to create different classification criteria, after which different category-entities can be created,
organizing some or all of said entities in a tree, with parent-child relationships, so that said entities correspond to the nodes of said tree, where it is not necessary that a graphical representation of said tree exists.
